(19) United States
(12) Patent Application Publication
(10) Pub. No.: US 2026/0217944 A1
(43) Pub. Date: Jul. 30, 2026

(54) ELASTOMER COMPOSITIONS WITH IMPROVED PROPERTIES

(71) Applicant: COMPAGNIE GENERALE DES ETABLISSEMENTS MICHELIN, Clermont-Ferrand (FR)

(72) Inventors: ETIENNE FLEURY, Clermont-Ferrand (FR); STEPHANE BADAIRE, Clermont-Ferrand (FR)

(21) Appl. No.: 19/159,059

(22) PCT Filed: Feb. 15, 2024
(86) PCT No.: PCT/EP2024/053903

§ 371 Date: Aug. 22, 2025

(30) Foreign Application Priority Data
Feb. 24, 2023 (FR) 2301727

(51) Int. Cl. C08K 3/04; B60C 1/00; C08K 3/06; C08K 3/22; C08K 3/36; C08K 5/09; C08K 5/31; C08K 5/47; C08K 5/548; C08K 7/24

(52) U.S. Cl. CPC C08K 3/04; B60C 1/00; C08K 3/06; C08K 3/36; C08K 5/09; C08K 5/31; C08K 5/47; C08K 5/548; C08K 7/24; C08K 2003/2296; C08K 2201/005; C08K 2201/006; C08K 2201/014

(57) ABSTRACT

The invention relates to an elastomer composition for heavy-duty tyres based on at least one elastomeric matrix, fillers including graphite and a reinforcing filler, and a vulcanization system, characterized in that:
the elastomeric matrix comprises at least 50 phr of a diene elastomer chosen from the group consisting of isoprene elastomers, butadiene elastomers and mixtures of these diene elastomers,
the reinforcing filler predominantly comprises an acetylene black,
the graphite has a crystallite size Lc in a range from 80 to 500 nm, more preferentially from 90 to 400 nm, more preferentially from 100 to 300 nm,
the total filler content is less than or equal to 65 phr.

### TECHNICAL FIELD

The field of the present invention is that of reinforced elastomer compositions used for manufacturing tyres which bear heavy loads, such as those intended to equip a heavy-goods vehicle, a civil engineering vehicle, a bus, an aircraft, etc.

### TECHNOLOGICAL BACKGROUND

Tyres intended to equip heavy-duty vehicles are provided with treads which have, in comparison with the treads of the tyres of light vehicles, in particular of passenger vehicles or vans, large thicknesses of rubber material, in order notably to withstand the weight that these vehicles transport. Typically, the wearing part of the tread of a heavy-duty vehicle may have a thickness of at least 15 mm, that of a civil engineering vehicle at least 30 mm, or even up to 120 mm. These tyres may notably have an axial width greater than 37 inches.

During rolling, the elastomer compositions, such as those of the tread, sidewalls, etc. of these tyres are subjected to mechanical stresses and aggressive conditions resulting notably from contact with the ground. In the case of a tyre fitted to a heavy-duty vehicle, the mechanical stresses and aggressive conditions are amplified by the effect of the weight borne by the tyre.

For example, mining vehicle tyres are subjected to high stresses, both i) locally, i.e. when rolling on macro-indenters represented by the stones that make up the tracks (crushed rock) and ii) globally, due to the high torque caused by the slopes of the tracks when leaving the mine shafts (slopes of about 10%) and by U-turns for loading and unloading manoeuvres.

In addition, in the case of vehicles intended for use in mines or quarries for transporting loads, access difficulties and performance requirements lead manufacturers of these vehicles to increase their load capacity. As a result, vehicles are becoming larger and larger, and therefore they themselves are becoming increasingly heavy and can carry increasingly heavy loads. The current masses of these vehicles can reach several hundred tons and the load to be transported is similarly high; the total mass can reach up to 600 tons.

The tyres of heavy-duty vehicles are consequently subjected to increasingly high stresses. They must have good wear properties, be capable of transmitting the necessary torque and withstand aggressive conditions, notably due to the stones encountered on the tracks.

These high stresses are also notably encountered on the treads of tyres fitted to agricultural vehicles due to the stony ground of arable land.

Tyres fitted to heavy construction vehicles that travel on both stony and asphalt ground are similarly stressed.

On account of the two aggravating factors, namely the weight borne by the tyre and the aggressive nature of the rolling surface, the wear resistance and tear strength of a tyre for a civil engineering vehicle, an agricultural vehicle or a heavy-goods vehicle prove to be crucial for minimizing the impact of the aggressive conditions encountered, notably by the tread.

It is thus important to have elastomer compositions for vehicle tyres, notably those bearing heavy loads, which contribute to the wear resistance and the resistance to aggressive conditions. These elastomer compositions must therefore be sufficiently stiff and also have good breaking strain and tear strength properties.

To solve this problem, it is known by those skilled in the art, for example, to use a large amount of reinforcing fillers in order to obtain good stiffness of the elastomer composition for this type of tyre, or to use increasingly fine reinforcing fillers.

However, the use of increasingly fine reinforcing fillers often requires an increase in the content of plasticizers, such as oils or resins, so as to overcome the difficulties of implementation and processability of this type of reinforcing filler. However, the presence of plasticizers in elastomer compositions causes degradation of certain mechanical properties of the elastomer compositions, such as the breaking strain properties.

Increasing the content of reinforcing fillers also has a drawback. It entrains significant internal heating problems in the reinforcing belt, which can lead to degradation of the tyre.

Specifically, due to the fact, firstly, that the tyres for heavy-duty vehicles are larger than tyres for passenger vehicles and, secondly, that elastomer compositions are subject to repeated and greater stresses and deformations given the load they bear, heat is generated. This heat generated when the tyre is in motion is dissipated into the environment more or less quickly depending on the thermal conductivity values of each composition of the tyre. When the thermal conductivity of an elastomer blend is too low, the heat accumulates and leads to bakelization of the composition. The tyre then loses its elastic properties, which is detrimental to its use.

Thus, when manufacturers seek to improve the stiffness and/or resistance to aggressive conditions of elastomer compositions for heavy-duty tyres, this improvement is often achieved at the expense of other properties, for instance the hysteresis of the materials and therefore ultimately at the expense of the temperature of the tyre in operation.

Document WO2013/186150 proposes a solution for improving the thermal conductivity of elastomer compositions. This document describes that the use of an acetylene black in the presence of silica makes it possible to improve both thermal conductivity and hysteresis.

There is thus still an unmet need for elastomer compositions for heavy-duty tyres, notably civil engineering tyres, which further meet the compromise of properties of resistance to aggressive conditions, stiffness, breaking strain and thermal conductivity; or even advantageously improve this compromise compared to compositions of the prior art.

The aim of the present invention is to meet this need.

Continuing their research, the Inventors unexpectedly identified that, for heavy-duty tyres, notably civil engineering tyres, the use of a specific graphite in an elastomer composition comprising an acetylene black made it possible to obtain a good compromise of properties of resistance to aggressive conditions, stiffness, breaking strain and thermal conductivity, or even to improve this compromise in properties compared to compositions of the prior art.

Advantageously, the amount of reinforcing fillers in the elastomer composition can even be reduced, which is economically and environmentally more favourable given the increasing scarcity of resources.

Thus, one subject of the invention is an elastomer composition for heavy-duty tyres based on at least one elastomeric matrix, fillers including graphite and a reinforcing filler, and a vulcanization system, characterized in that:
the elastomeric matrix comprises at least 50 phr of a diene elastomer chosen from the group consisting of isoprene elastomers, butadiene elastomers and mixtures of these diene elastomers,
the reinforcing filler predominantly comprises an acetylene black,
the graphite has a crystallite size Lc in a range from 80 to 500 nm, more preferentially from 90 to 400 nm, more preferentially from 100 to 300 nm,
the total filler content is less than or equal to 65 phr.

Another subject of the invention relates to a heavy-duty tyre comprising at least one composition as described above. Preferably, the tyre is a civil engineering tyre or a heavy-goods tyre.

### DETAILED DESCRIPTION OF THE INVENTION

### Definitions

The expression “composition based on” should be understood as meaning a composition including the mixture and/or the product of the in situ reaction of the various constituents used, some of these constituents being able to react and/or being intended to react with each other, at least partially, during the various phases of manufacture of the composition; the composition thus possibly being in the totally or partially crosslinked state or in the non-crosslinked state.

For the purposes of the present invention, the expression “part by weight per hundred parts by weight of elastomer” (or phr) should be understood as meaning the part by mass per hundred parts by mass of elastomer.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b).

When reference is made to a “predominant” compound, this means, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. Similarly, a “predominant” filler is the one representing the greatest mass among the fillers of the composition. By way of example, in a system comprising only one elastomer, the latter is predominant for the purposes of the present invention; and in a system comprising two elastomers, the predominant elastomer represents more than half of the mass of the elastomers. In contrast, a “minor” compound is a compound which does not represent the greatest mass fraction among the compounds of the same type. Preferably, the term “predominant” refers to a compound present to more than 50%, preferably more than 60%, 70%, 80%, 90% by weight, and more preferentially the “predominant” compound represents 100% by weight relative to the total weight of the compounds of the same type.

The compounds mentioned in the description may be of fossil origin or may be biobased. In the latter case, they may be partially or completely derived from biomass or obtained from renewable raw materials derived from biomass. Obviously, the compounds mentioned may also be derived from the recycling of already-used materials, i.e. they may be partly or totally derived from a recycling process, or obtained from raw materials which are themselves derived from a recycling process. Polymers, plasticizers, fillers, and the like, are notably concerned.

The term “heavy-duty vehicle tyre” means tyres, in particular radial tyres, for heavy-duty vehicles, for instance trucks, aircraft, underground transport vehicles, civil engineering machinery, tractors, trailers or buses, equipped with wheels whose rims have a nominal diameter greater than or equal to 19.5 inches. A heavy-duty vehicle is distinguished by the dimensions of its axle(s) and notably by its gross vehicle weight rating, which is greater than or equal to 3.5 tons.

The term “tread” means the outer layer of the tyre that is in direct contact with the rolling surface.

“Acetylene black” or “acetylene-derived carbon black” or else “acetylene carbon black” means any carbon black obtained by thermal decomposition of acetylene used as raw material.

The term “diene elastomer” (or, without distinction, rubber), whether natural or synthetic, should be understood, in a known manner, as meaning an elastomer consisting, at least partly (i.e., a homopolymer or a copolymer) of diene monomer units (monomers bearing two conjugated or non-conjugated carbon-carbon double bonds). In the present patent application, diene elastomers are by definition non-thermoplastic. Preferably, when the diene elastomers are copolymers, they are random polymers. Diene elastomers may be classified into two categories: “essentially unsaturated” or “essentially saturated”. The term “essentially unsaturated” generally means a diene elastomer resulting at least in part from conjugated diene monomers having a content of units of diene origin (conjugated dienes) which is greater than 15% (mol %); therefore, diene elastomers such as butyl rubbers or copolymers of dienes and of α-olefins of EPDM type do not fall within the preceding definition and can notably be described as “essentially saturated” diene elastomers (low or very low content, always less than 15 mol %, of units of diene origin). The diene elastomers that may be used in the context of the invention are essentially unsaturated diene elastomers. Butyl elastomers thus cannot be used in the context of the present invention since they are essentially saturated diene elastomers.

All the glass transition temperature “Tg” values are measured in a known manner by DSC (Differential Scanning calorimetry) according to the standard ASTM D3418 (2008).

### Elastomeric Matrix

As indicated above, the elastomer composition of the invention comprises an elastomeric matrix.

By definition, the elastomeric matrix denotes all the elastomers present in the composition. A polymer that does not have elastic properties such as those of natural rubber will therefore not be considered as part of the elastomeric matrix and its content will not be taken into account in the calculation of the phr.

The elastomeric matrix of the elastomer composition of the invention comprises at least 50 phr of a diene elastomer chosen from the group consisting of isoprene elastomers, butadiene elastomers and blends of these diene elastomers. For example, the elastomeric matrix may comprise an isoprene elastomer or a blend of isoprene elastomers, a butadiene elastomer or a blend of butadiene elastomers, or even a blend of isoprene and butadiene elastomers. These diene elastomers have a content of units of diene origin (conjugated dienes) of more than 15 mol %. Thus, the elastomeric matrix of the composition of the present invention comprises at least 50 phr of a diene elastomer having a content of units of diene origin (conjugated dienes) of more than 15 mol %; this elastomer being chosen from the group consisting of isoprene elastomers, butadiene elastomers and blends of these diene elastomers. In addition to the abovementioned diene elastomers, the elastomeric matrix may also comprise thermoplastic elastomers.

The term “isoprene elastomer” means, in a known manner, a homopolymer or copolymer of isoprene. Isoprene copolymers comprise at least one isoprene monomer and at least one other monomer different from the isoprene monomer, the diene monomer content being greater than mol %. Consequently, butyl rubber is excluded from the definition of isoprene elastomer. The other monomer may be ethylene, an olefin or a conjugated or non-conjugated diene.

The term “butadiene elastomer” means, in a known manner, a homopolymer or copolymer of butadiene. Butadiene copolymers comprise at least one butadiene monomer and one other monomer different from the butadiene monomer; the diene monomer content being greater than mol %. The other monomer may be ethylene, an olefin or a conjugated or non-conjugated diene.

Conjugated dienes that are suitable include conjugated dienes containing from 4 to 12 carbon atoms, in particular 1,3-dienes, notably such as 1,3-butadiene and isoprene.

Non-conjugated dienes that are suitable include non-conjugated dienes containing from 6 to 12 carbon atoms, such as 1,4-hexadiene, ethylidenenorbornene or dicyclopentadiene. 35

Olefins that are suitable include vinylaromatic compounds containing from 8 to 20 carbon atoms and aliphatic α-monoolefins containing from 3 to 12 carbon atoms. Vinylaromatic compounds that are suitable include, for example, styrene, ortho-, meta- or para-methylstyrene, the “vinyltoluene” commercial mixture and para-(tert-butyl) styrene. Aliphatic α-monoolefins that are suitable notably include acyclic aliphatic α-monoolefins containing from 3 to 18 carbon atoms.

More particularly, the isoprene elastomer may be chosen from the group consisting of natural rubber (NR), synthetic polyisoprenes (IR), different isoprene copolymers and mixtures of these elastomers. Among the isoprene copolymers, mention will be made in particular of isoprene-styrene (SIR). Isobutene/isoprene copolymers (butyl rubber-IIR) are not among the isoprene copolymers that can be used in the context of the invention because they are essentially saturated copolymers with a content of units of diene origin of less than 15 mol %.

This isoprene elastomer is preferably natural rubber or a synthetic cis-1,4-polyisoprene. Among these synthetic polyisoprenes, use is preferably made of polyisoprenes with a content (mol %) of cis-1,4-bonds of greater than 90%, even more preferentially greater than 98%.

More particularly, the butadiene elastomer may be chosen from the group consisting of polybutadienes (BR), different butadiene copolymers and mixtures of these elastomers. Among the butadiene copolymers, mention will be made in particular of ethylene/butadiene (EBR), butadiene/styrene (SBR), isoprene/butadiene (BIR) or isoprene/butadiene/styrene (SBIR) copolymers. For the sake of clarity, isoprene/butadiene and isoprene/butadiene/styrene elastomers are classified as butadiene copolymers and not as isoprene copolymers.

The following are suitable: polybutadienes and in particular those with a content (mol %) of 1,2-units of between 4% and 80% or those with a content (mol %) of cis-1,4-units of greater than 80%, polyisoprenes, butadiene/styrene copolymers and in particular those with a Tg (glass transition temperature (Tg, measured according to ASTM D3418-99)) of between 0° C. and −90° C. and more particularly between −10° C. and −70° C., a styrene content of between 1% and 60% by weight and more particularly between 20% and 50%, a content (mol %) of 1,2-bonds of the butadiene part of between 4% and 75% and a content (mol %) of trans-1,4-bonds of between 10% and 80%, butadiene/isoprene copolymers and notably those with an isoprene content of between 5% and 90% by weight and a Tg of from −40° C. to −80° C., or isoprene/styrene copolymers and notably those with a styrene content of between 5% and 50% by weight and a Tg of between −5° C. and −50° C. In the case of the butadiene/styrene/isoprene copolymers, those with a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2-plus 3,4-units of the isoprene part of between 5% and 70% and a content (mol %) of trans-1,4-units of the isoprene part of between 10% and 50%, and more generally any butadiene/styrene/isoprene copolymer with a Tg of between −5° C. and −70° C., are notably suitable.

Advantageously, the diene elastomer may be chosen from the group consisting of natural rubber (NR), synthetic polyisoprenes (IR), isoprene/styrene copolymer (SIR), polybutadienes (BR), ethylene/butadiene copolymers (EBR), butadiene/styrene copolymers (SBR), isoprene/butadiene copolymers (BIR), isoprene/butadiene/styrene copolymers (SBIR) and blends of these elastomers.

Even more advantageously, the diene elastomer may be chosen from the group consisting of natural rubber (NR), synthetic polyisoprenes (IR), polybutadienes (BR), ethylene/butadiene copolymers (EBR), butadiene/styrene copolymers (SBR) and blends of these elastomers.

Even more advantageously, the diene elastomer may be an isoprene elastomer; even more preferentially, it is chosen from the group consisting of natural rubber (NR), synthetic polyisoprenes (IR) and blends of these elastomers.

The abovementioned diene elastomers may be modified, i.e. either coupled and/or star-branched, or functionalized, or coupled and/or star-branched and simultaneously functionalized.

Thus, the abovementioned diene elastomers, notably when they are synthetic, can be coupled and/or star-branched, for example by means of a silicon or tin atom which connects the elastomer chains together.

The abovementioned diene elastomers can be simultaneously or alternatively functionalized and comprise at least one functional group. The term “functional group” means a group comprising at least one heteroatom chosen from Si, N, S, O or P. Particularly suitable as functional groups are those comprising at least one function, such as: silanol, an alkoxysilane, a primary, secondary or tertiary amine which is cyclic or non-cyclic, a thiol or an epoxide.

In a particularly advantageous manner, the elastomer composition of the invention may comprise from 60 to 100 phr, preferably from 70 to 100 phr, preferably from 80 to 100 phr, preferably from 90 to 100 phr, of a diene elastomer chosen from the group consisting of isoprene elastomers, butadiene elastomers and blends of these elastomers. According to one embodiment, the rubber composition may comprise from 60 to 99 phr, preferably from 70 to 99 phr, for example from 80 to 98 phr, for example 90 to 97 phr, of a diene elastomer chosen from the group consisting of isoprene elastomers, butadiene elastomers and blends of these elastomers; the remainder possibly being another different diene elastomer.

More particularly advantageously, the elastomer composition of the invention may comprise from 60 to 100 phr, preferably from 70 to 100 phr, preferably from 80 to 100 phr, preferably from 90 to 100 phr, of an isoprene elastomer and blends of these elastomers. According to one embodiment, the rubber composition may comprise from 60 to 99 phr, preferably from 70 to 99 phr, for example from 80 to 98 phr, for example from 90 to 97 phr, of an isoprene elastomer; the remainder possibly being another diene elastomer, preferentially a butadiene elastomer as defined above.

Even more particularly advantageously, the elastomer composition of the invention may comprise from 60 to 100 phr, preferably from 70 to 100 phr, preferably from 80 to 100 phr, preferably from 90 to 100 phr, of a diene elastomer chosen from the group consisting of natural rubber, synthetic polyisoprene and blends of these elastomers. According to one embodiment, the rubber composition may comprise from 60 to 99 phr, preferably from 70 to 99 phr, for example from 80 to 98 phr, for example from 90 to 97 phr, of a diene elastomer chosen from the group consisting of natural rubber, synthetic polyisoprene and blends of these elastomers; the remainder possibly being another diene elastomer, preferentially a butadiene elastomer as defined above.

### Filler

The elastomer composition of the invention comprises fillers including a reinforcing filler and graphite.

The term “filler” herein refers to any type of filler, whether reinforcing or non-reinforcing or inert. As a reinforcing filler, it is known to those skilled in the art that this is carbon black or inorganic reinforcing fillers such as silica or alumina. As a non-reinforcing or inert filler, it is known to those skilled in the art that this is graphite, clay, talc, mica, etc. In the context of the present invention, zinc oxide is not considered a non-reinforcing filler. It is an activator of the vulcanization system.

The total filler content (i.e., the sum of the reinforcing filler content and the non-reinforcing filler content) in the elastomer composition of the present invention is less than or equal to 65 phr, preferably less than or equal to 60 phr, preferably less than or equal to 55 phr. More preferentially, the total filler content may be in a range from 20 to 65 phr, more preferentially in a range from 25 to 60 phr, even more preferentially from 25 to 55 phr. At this total filler content, a good compromise is obtained between resistance to aggressive conditions, stiffness, breaking strain and thermal conductivity.

### Reinforcing Filler

The elastomer composition of the invention comprises a reinforcing filler, this reinforcing filler predominantly comprising an acetylene black. In addition to the acetylene black, which is the majority reinforcing filler, the elastomer composition of the invention may optionally also comprise a second reinforcing filler such as silica and/or optionally a third reinforcing filler such as a carbon black different from the acetylene carbon black, for example.

The total reinforcing filler content, i.e. the content of acetylene black, the content of carbon black different from the acetylene black if present and the content of silica when present, is less than or equal to 60 phr, more preferentially less than or equal to 55 phr, more preferentially less than or equal to 50 phr, more preferentially less than or equal to 45 phr. This content of reinforcing filler is advantageously greater than or equal to 20 phr, more preferentially greater than or equal to 25 phr, more preferentially greater than or equal to 30 phr. Preferentially, the content of reinforcing fillers in the elastomer composition is within a range extending from 20 phr to 60 phr, more preferentially from 25 phr to 55 phr, more preferentially from 30 phr to 45 phr.

### Acetylene Black

Preferentially, the acetylene black represents more than 55% by weight of the total weight of the reinforcing filler, even more preferentially more than 60% by weight, even more preferentially more than 80% by weight, and even more preferentially represents 100% by weight of the total weight of the reinforcing filler.

Thus, preferentially, the content of reinforcing filler is less than or equal to 60 phr, more preferentially less than or equal to 55 phr, more preferentially less than or equal to 50 phr, more preferentially less than or equal to 45 phr, and the acetylene black represents more than 55% by weight of the total weight of the reinforcing filler, even more preferentially more than 60% by weight, even more preferentially more than 80% by weight, and even more preferentially represents 100% by weight of the total weight of the reinforcing filler.

Even more preferentially, the content of reinforcing fillers in the elastomer composition is in a range from 20 phr to 60 phr, more preferentially from 25 phr to 55 phr, more preferentially from 30 phr to 45 phr, and the acetylene black represents more than 55% by weight of the total weight of the reinforcing filler, even more preferentially more than 60% by weight, even more preferentially more than 80% by weight, and even more preferentially represents 100% by weight of the total weight of the reinforcing filler.

The reinforcing fillers that may be used in the context of the present invention are described hereinbelow.

The reinforcing filler predominantly comprises an acetylene black.

The acetylene black that may be used in the context of the present invention is an amorphous, finely divided carbon black well known to those skilled in the art of tyres.

It is generally obtained by thermal decomposition of a specific raw material which is acetylene. The acetylene blacks that may be used in the context of the present invention may have a BET specific surface area, measured according to the standard ASTM D-3037 dated 1993, of greater than or equal to 40 m²/g, preferentially greater than or equal to 50 m²/g, preferably in a range from 55 to 160 m²/g, more preferentially from 60 to 150 m²/g.

The acetylene blacks that may be used in the present invention may preferentially have an iodine absorption number measured according to the standard ASTM D1510-21 of greater than or equal to 65 m²/g, more preferentially greater than or equal to 70 m²/g, even more preferentially in a range from 80 to 140 m²/g, even more preferentially from 85 to 130 m²/g.

The acetylene blacks that may be used in the present invention may preferentially have an oil absorption number measured according to the standard ASTM D1510-21 of greater than or equal to 150 m²/g, more preferentially greater than or equal to 155 m²/g, even more preferentially in a range from 160 to 260 m²/g, even more preferentially from 160 to 230 m²/g. Acetylene blacks are well known to those skilled in the art and are commercially available from the companies Denka, Orion etc.

Carbon Black Other than the Acetylene-Derived Carbon Black

According to one embodiment of the invention, the elastomer composition may comprise, in addition to the acetylene black, another carbon black different from the acetylene black.

The carbon black different from the acetylene black is an amorphous, finely divided carbon black well known to those skilled in the art of tyres. It is generally obtained by thermal decomposition or incomplete combustion of hydrocarbons using the heat produced by the complete combustion of a fuel by air. The process for obtaining carbon black is the furnace process. Suitable carbon blacks different from the acetylene black include all carbon blacks notably known as ASTM-grade carbon black (carbon black classified according to the standard ASTM D1765-17). Among said carbon blacks, mention will more particularly be made of the reinforcing carbon blacks of the 100, 200 and 300 series, or the blacks of the 500, 600 or 700 series (ASTM D-1765-2017 grades), for instance the N115, N134, N234, N326, N330, N339, N347, N375 and N550 blacks. These carbon blacks may be used in isolated form, as commercially available, or in any other form, for example as support for some of the rubber engineering additives used. The carbon blacks might, for example, be already incorporated into the diene elastomer, notably an isoprene elastomer, in the form of a masterbatch (see, for example, patent applications WO 97/36724-A2 and WO 99/16600-A1).

The carbon black different from the acetylene black, which may optionally be used in the elastomer compositions, has little or no conductive properties. It therefore does not belong to the category of conductive carbon blacks. Carbon blacks are distinguished from conductive carbon blacks notably by their structure, which can be measured by the oil absorption number evaluated according to the standard ASTM D2414-22. Preferentially, the carbon black different from the acetylene black that may be used in the present invention has an oil absorption number measured according to the standard ASTM D2414-22 (“OAN”) in a range from 30 ml/100 g to 150 ml/100 g. Carbon blacks having conductive properties, also known as conductive carbon black, have an oil absorption number measured according to the standard ASTM D2414-22 of generally greater than 155 ml/100 g.

Preferentially, the elastomer composition of the invention contains less than 10 phr of carbon black different from the acetylene black. More preferentially, the elastomer composition of the invention is free of carbon black different from the acetylene black.

### Silica

According to one embodiment of the invention, the elastomer composition may comprise, in addition to the acetylene black, a silica, notably a precipitated silica, as reinforcing filler and may also comprise an agent for coupling the silica to the diene elastomer of the elastomeric matrix. In a known manner, the silicas may notably be characterized by the presence of hydroxyl (—OH) groups at their surface.

The silica (SiO₂) used may be any reinforcing silica known to those skilled in the art, notably any precipitated or fumed silica with a BET specific surface area and also a CTAB specific surface area both of less than 450 m²/g, preferably in a range extending from 30 to 400 m²/g, notably from 60 to 300 m²/g.

Use may be made of any type of precipitated silica, notably highly dispersible precipitated silicas (HDS). These precipitated silicas, which may or may not be highly dispersible, are well known to those skilled in the art. Mention may be made, for example, of the silicas described in patent applications WO 03/016215-A1 and WO 03/016387-A1. Among the commercial HDS silicas, use may notably be made of the Ultrasil® 5000GR and Ultrasil® 7000GR silicas from the company Evonik or the Zeosil® 1085GR, Zeosil® 1115 MP, Zeosil® 1165MP, Zeosil® Premium 200MP and Zeosil® HRS 1200 MP silicas from the company Solvay. Use may be made, as non-HDS silica, of the following commercial silicas: the Ultrasil® VN2GR and Ultrasil® VN3GR silicas from the company Evonik, the Zeosil® 175GR silica from the company Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from the company PPG.

The physical state in which the reinforcing inorganic filler is provided is not important, whether it be in the form of a powder, micropearls, granules, beads or any other appropriate densified form. Needless to say, the term “reinforcing inorganic filler” also refers to mixtures of different reinforcing inorganic fillers, in particular of silicas as described above.

The content of silica used is always lower than the content of carbon black used, since silica is an inorganic reinforcing filler present in a minor amount in the elastomer composition. Preferentially, silica represents 45% by weight or less of the total weight of the reinforcing filler, more preferentially represents 40% by weight or less, and more preferentially represents 20% by weight or less of the total weight of the reinforcing filler.

The BET specific surface area of the silica is determined by gas adsorption using the Brunauer-Emmett-Teller method described in “The Journal of the American Chemical Society”, (Vol. 60, page 309, February 1938), and more specifically according to a method derived from the standard NF ISO 5794-1, appendix E, of June 2010 [multipoint (5 point) volumetric method-gas: nitrogen-degassing under vacuum: one hour at 160° C.-relative pressure range p/po: 0.05 to 0.17].

For inorganic fillers such as silica, for example, the CTAB specific surface area values were determined according to the standard NF ISO 5794-1, appendix G of June 2010. The process is based on the adsorption of CTAB (N-hexadecyl-N,N,N-trimethylammonium bromide) on the “outer” surface of the reinforcing filler.

In order to couple the silica to the diene elastomer, use may be made, in a well-known manner, of an at least difunctional coupling agent (or bonding agent) intended to provide a satisfactory connection, of chemical and/or physical nature, between the silica (surface of its particles) and the diene elastomer. Use is made in particular of organosilanes or polyorganosiloxanes which are at least difunctional. The term “difunctional” refers to a compound having a first functional group that is capable of interacting with the inorganic filler and a second functional group that is capable of interacting with the diene elastomer. For example, such a difunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are chosen from the group consisting of organosilane polysulfides (which may be symmetrical or asymmetrical) such as bis(3-triethoxysilylpropyl) tetrasulfide, abbreviated to TESPT, sold under the name Si69 by the company Evonik, or bis(triethoxysilylpropyl) disulfide, abbreviated to TESPD, sold under the name Si75 by the company Evonik, polyorganosiloxanes, mercaptosilanes, blocked mercaptosilanes, such as S-(3-(triethoxysilyl) propyl) octanethioate sold by the company Momentive under the name NXT Silane. More preferentially, the organosilane is an organosilane polysulfide.

Typically, the content of coupling agent represents from 0.5% to 15% by weight, relative to the amount of reinforcing inorganic filler. This content is readily adjusted by a person skilled in the art depending on the content of silica used in the elastomer composition of the invention.

The elastomer compositions of the invention may also contain silica coating agents when such a filler is used, thereby improving their ability to be used in the green state. These coating agents are well known (see, for example, patent applications WO 2006/125 533-A1, WO 2007/017 060-A1 and WO 2007/003 408-A1), for example, mention may be made of hydrolysable silanes such as hydroxysilanes (see, for example, WO 2009/062 733-A2)alkylalkoxysilanes, polyols (for example diols or triols), polyethers (for example polyethylene glycols), primary, secondary or tertiary amines, hydroxylated or hydrolysable polyorganosiloxanes (for example α,ω-dihydroxy-polyorganosilanes (see, for example, EP 0 784 072-A1).

When present, the content of silica in the elastomer composition that may be used in the context of the invention is preferentially in a range from 5 to 20 phr, more preferentially from 7 to phr.

### Graphite

The composition of the invention comprises at least one graphite. The elastomer composition of the invention may contain a single graphite as described below or a mixture of several graphites as described below.

The term “graphite” generally refers to a set of stacked graphene planes, graphene being a sheet of atomic thickness in which the carbon atoms are arranged in an essentially hexagonal lattice. Unlike the abovementioned carbon blacks, graphite thus has a crystalline structure.

Graphite may be natural or synthetic. When graphite is synthetic, it may notably be obtained by a complex process of baking petroleum coke at very high temperature.

Graphite is not considered as a reinforcing filler and is therefore not taken into account in the calculation of the reinforcing fillers. Graphite is a filler and is thus taken into account in the calculation of the total filler content.

The graphite that may be used in the context of the present invention has a crystallite size, denoted Lc, in a range from 80 to 500 nm, more preferentially from 90 to 400 nm, and more preferentially from 100 to 300 nm. The measurement of the crystallite size is described in paragraph 1 of the methods and measurements section.

The graphite that may be used in the context of the present invention may have a BET specific surface area in a range from 10 to 50 m²/g; preferably ranging from 15 to 40 m²/g, even more preferentially ranging from 20 to 30 m²/g. The measurement of the BET specific surface area is described in paragraph 2 of the methods and measurements section.

The graphite that may be used in the context of the present invention may have a particle size distribution D90 in a range from 50 to 150 μm, more preferentially ranging from 60 to 140 μm, even more preferentially ranging from 70 to 130 μm. The D₉₀ corresponds to the 90th percentile of the mass distribution of particle sizes, i.e. 90% by mass of the particles have a size smaller than the D₉₀ and 10% by mass of the particles have a size greater than the D₉₀. It is expressed in μm. The measurement of the D₉₀ is described in paragraph 3 of the methods and measurements section.

Preferentially, the graphite that may be used in the context of the present invention is an expanded graphite.

Preferably, the graphite content in the elastomer composition of the present invention is in a range from 1 to 12 phr, more preferentially from 1 to 11 phr.

Preferentially, the mass ratio of graphite to acetylene black in the elastomer composition is in a range from 0.05 to 0.5, preferably from 0.06 to 0.4.

The graphites that may be used in the context of the present invention are commercially available from suppliers such as Imerys, for example.

Surprisingly, the inventors have identified that the use of the above-mentioned graphite in an elastomer composition for heavy-duty tyres, notably civil engineering tyres, makes it possible to obtain a good compromise of properties of resistance to aggressive conditions, stiffness, breaking strain and thermal conductivity, or even to improve this compromise of properties compared to compositions of the prior art. Advantageously, the amount of reinforcing fillers in the elastomer composition can even be reduced.

### Vulcanization System

The elastomer composition of the invention comprises a vulcanization system known to those skilled in the art in the field of elastomer compositions for tyres.

The sulfur can be provided in any form, notably in the form of molecular sulfur or of a sulfur-donating agent.

At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or known vulcanization retarders. It should be noted that zinc oxide is considered as a vulcanization activator and not as a filler. It is therefore not taken into account in the calculation of the total filler content.

Sulfur is used in a preferential content in a range extending from 0.5 to 10 phr, in particular from 1 to 5 phr.

The vulcanization accelerator is used in a preferential range extending from 0.5 to 10 phr, more preferentially in a range extending from 0.5 to 5.0 phr.

Use may be made, as accelerator, of any compound that is capable of acting as an accelerator of the vulcanization of diene elastomers in the presence of sulfur, notably accelerators of the thiazole type, and also derivatives thereof, or accelerators of sulfenamide, thiuram, dithiocarbamate, dithiophosphate, thiourea and xanthate types. As examples of such accelerators, mention may notably be made of the following compounds: 2-mercaptobenzothiazyl disulfide (abbreviated as MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and mixtures of these compounds.

### Plasticizers

The elastomer composition of the invention may optionally include at least one plasticizer.

In a manner known to those skilled in the art of elastomer compositions for tyres, this plasticizer is preferably chosen from hydrocarbon-based resins with a high glass transition temperature (Tg), hydrocarbon-based resins with a low Tg, plasticizing oils and mixtures thereof. Preferably, the plasticizer is chosen from high-Tg hydrocarbon-based resins, plasticizing oils and mixtures thereof.

By definition, a high-Tg hydrocarbon-based resin is a solid at room temperature and ambient pressure (20° C., 1 atm), whereas a plasticizing oil is liquid at room temperature and a low-Tg hydrocarbon-based resin is viscous at room temperature.

The total plasticizer content in the elastomer composition of the invention may be in a range from 0 to 10 phr, more preferentially from 0 to 5 phr.

Preferentially, if the elastomer composition comprises a plasticizer, the plasticizer is a hydrocarbon-based resin with a Tg greater than 20° C.

Preferentially, if the elastomer composition comprises a plasticizer, preferably a hydrocarbon-based resin with a Tg greater than 20° C., the plasticizer content is in a range from 1 to 10 phr, preferably from 1 to 5 phr.

Preferentially, the elastomer composition is free of plasticizer.

Hydrocarbon-based resins, also known as hydrocarbon-based plasticizing resins, are polymers that are well known to those skilled in the art, essentially based on carbon and hydrogen but which may include other types of atoms, for example oxygen, and can be used in particular as plasticizers or tackifiers in polymeric matrices. They are by nature at least partially miscible (i.e. compatible) at the contents used with the polymer compositions for which they are intended, so as to act as true diluents. They have been described, for example, in the book entitled “Hydrocarbon Resins” by R. Mildenberg, M. Zander and G. Collin (New York, V C H, 1997, ISBN 3-527-28617-9), Chapter 5 of which is devoted to their applications, particularly in the tyre rubber engineering field (5.5. “Rubber Tires and Mechanical Goods”). In a known manner, these hydrocarbon resins can also be described as thermoplastic resins in the sense that they soften when heated and can thus be moulded.

The hydrocarbon-based resins may be aliphatic, aromatic or of the aliphatic/aromatic type, i.e. based on aliphatic and/or aromatic monomers. They may be natural or synthetic and may or may not be petroleum-based (if such is the case, they are also known as petroleum resins).

The plasticizers are commercially available from suppliers such as Arizona, Kraton, Exxon, etc.

### Other Additives

The elastomer compositions in accordance with the invention may also include all or some of the usual additives and processing aids known to those skilled in the art and usually used in elastomer compositions for tyres, for instance fillers (reinforcing or non-reinforcing fillers other than those mentioned previously), pigments, protective agents, such as antiozone waxes, chemical antiozonants, antioxidants, anti-fatigue agents or reinforcing resins (such as described, for example, in patent application WO 02/102 69).

### Manufacture of the Elastomer Compositions

The elastomer compositions in accordance with the invention may be manufactured in appropriate mixers using two successive preparation phases that are well known to those skilled in the art:
a first phase of thermomechanical working or kneading (known as the “non-productive” phase), that can be performed in a single thermomechanical step during which all the necessary constituents, notably the elastomeric matrix, the fillers (notably the acetylene black and the graphite), and the various other optional additives, with the exception of the crosslinking system, are introduced into an appropriate mixer, such as a standard internal mixer (for example of ‘Banbury’ type). The incorporation of the filler into the elastomer may be performed in one or more portions while thermomechanically kneading. In the case where the filler is already incorporated, totally or partly, into the elastomer in the form of a masterbatch, as is described, for example, in patent applications WO 97/36724 or WO 99/16600, it is the masterbatch which is directly kneaded and, where appropriate, the other elastomers or fillers present in the composition which are not in masterbatch form, and also the optional various other additives, with the exception of the crosslinking system, are incorporated;
The non-productive phase may be performed at high temperature, up to a maximum temperature in a range from 110° C. to 200° C., preferably ranging from 130° C. to 185° C., for a period of time generally in a range from 2 to 10 minutes.
a second phase of mechanical working (known as the “productive” phase), which is performed in an external mixer, such as an open mill, after cooling the mixture obtained during the first non-productive phase down to a lower temperature, typically below 120° C., for example in a range from 40° C. to 100° C. The crosslinking system is then incorporated and the combined mixture is then mixed for a few minutes, for example in a range from 5 to 15 min.

The final composition thus obtained is then calendered, for example in the form of a sheet or a plaque, notably for laboratory characterization, or is extruded in the form of a rubber semi-finished elastomeric product (or profiled element) that can be used for manufacturing a tyre.

The composition may be either in the green state (before crosslinking or vulcanization) or in the cured state (after crosslinking or vulcanization), or may be a semi-finished product which can be used in a tyre.

The composition may be crosslinked in a manner known to those skilled in the art, for example at a temperature in a range from 100° C. to 200° C., under pressure.

### Tyre

A subject of the present invention is also a tyre comprising an elastomer composition of the invention as described above.

Given the improved compromise of properties in the context of the present invention, the tyre is a tyre for heavy-duty vehicles, advantageously chosen from the group consisting of heavy-goods tyres, civil engineering tyres, mining tyres, aircraft tyres, bus tyres, underground transport tyres and agricultural tyres.

The elastomer composition of the invention can be used in any type of position in these various tyres.

The tyre according to the invention has improved resistance to aggressive conditions, improved stiffness, improved breaking strain and improved thermal conductivity. It therefore has improved endurance and, given its good thermal conductivity, can roll faster in safety.

### Methods and Measurements:

### 1—Measurement of the Size of Crystallites Lc by X-Ray Diffraction

The size of the crystallites Lc is determined from the full width at half maximum (commonly referred to as FWHM) of the peaks obtained by X-ray diffraction analysis.

The contribution to the broadening of the diffraction peak is mainly related to the size of the crystallites, the presence of irregularities in the atomic stacking, point, linear or plane defects, and finally partly to the instrument. For graphite powder, only the size of the crystallites is considered significant and will be measured using Scherrer's formula:

$$Lc = \frac{K * λ}{FWHM * cos θ} \qquad [ Math 1 ]$$

where K is the aspect ratio (0.89), λ the wavelength of Cu Kα (1.541874 Å) and θ is the angle of the plane diffraction peak (002) (in rad).

The preparation and acquisition follow the method described in the standards AFNOR NF EN 13925-1, NF EN 13925-2, NF EN 13925-3 published in 2003.

The data are collected using an Empyrean diffractometer from Malvern PANalytical coupled with a PIXcel3D-Medipix3 detector. The diffractometer has the following features indicated in Table 1:

TABLE 1

| Instrument | Empyrean |
|---|---|
| X-Ray detector | PIXcel3D-Medipix3 |
| Geometry | Bragg-Brentano |
| X-Ray source | Cu-Kα |
| Generator parameters | 45 kV-40 mA |
| Scan speed | 0.07°/s |
| Sample spinning | 120 rpm |

Table 1: Instrument data and measurement parameters

The data were analysed using the PANalytical X'Pert HighScore Plus software.

### 2—Measurement of the BET Specific Surface Area of Graphite

The method is based on recording the absorption isotherm of liquid nitrogen in the range p/p0=0.04-0.26 at 77 K. Following the procedure proposed by Brunauer, Emmett and Teller (Adsorption of Gases in Multimolecular Layers, J. Am. Chem. Soc., 1938, 60, 309-319), the monolayer capacity can be determined. Based on the cross-section of the nitrogen molecule, the monolayer capacity and the weight of the sample, the specific surface area can then be calculated.

### 3—Measurement of the Size of the Graphite Particles

The graphite particle size mass distribution may be measured by laser particle size analysis, on a Mastersizer 3000 device from the company Malvern. The measurement is performed by the liquid route, diluted in alcohol after an ultrasound pretreatment for 1 min in order to guarantee the dispersion of the particles. The measurement is performed in accordance with the standard ISO-13320-1 of 2009 and makes it possible notably to determine the D₉₀, that is to say the mean diameter below which 90% by mass of the total population of particles is present.

### 4—Thermal Conductivity:

The thermal conductivity of a material is a physical quantity that characterizes the ability of a material to allow heat transfer by conduction. It represents the amount of heat transferred per unit of surface area and time, under a temperature gradient of 1 degree Kelvin and per meter. It is expressed in W·m⁻¹·K⁻¹. Thus, a thermal conductivity of 1 W·m⁻¹·K⁻¹ represents the amount of heat that propagates through a material by thermal conduction, through a surface area of 1 m², over a distance of 1 m.

Thermal conductivity is measured at room temperature (23° C.) on a Hotdisk TPS 2500 thermal analyser with a type 5501 probe, according to the standard ISO 22007-2:2015. The test specimen (consisting of the cured composition to be analysed) is circular in shape (diameter 5 cm, thickness 5 mm) and the measurement is taken in the direction of the thickness.

The results are shown in base 100, the arbitrary value 100 being assigned to the control in order to calculate and compare the thermal conductivity of the different samples tested. The value in base 100 for the test sample is calculated according to the operation: (thermal conductivity value of the test sample/thermal conductivity value of the control)×100. In this way, a result lower than 100 will indicate a reduction in thermal conductivity and thus a reduction in heat transfer by conduction. Conversely, a result higher than 100 will indicate an increase in thermal conductivity and thus an improvement in heat transfer by conduction.

### 5—Tensile Tests:

These tensile tests are used to determine the rupture properties. Unless otherwise indicated, they are based on the French standard NF T46-002 of September 1988.

Processing the tensile test recordings makes it possible to plot the curve of modulus as a function of the elongation. The breaking stress (in MPa) and elongation at break (in %) values are recorded.

All these tensile test measurements are performed at a temperature of 60° C.±2° C., and under the standard hygrometry conditions (50%±5% relative humidity), according to French standard NF T 40-101 (December 1979).

Thus, the energy to bring about breaking (breaking energy) of the test specimen, which is the product of the breaking stress and the elongation at break (breaking energy=breaking stress*elongation at break), may be determined.

The results are indicated on a basis of 100; the arbitrary value 100 is attributed to the control, respectively, for the breaking stress, the elongation at break and the breaking energy. A result of less than 100 for the breaking stress, the elongation at break or the breaking energy indicates a decrease in the value concerned, which corresponds to a reduction in the breaking strain property, and, conversely, a result greater than 100 indicates an increase in this value, which corresponds to an improvement in the breaking strain.

### 6—Mechanical Strength in the Presence of Crack Initiation Sites

Measurement of the mechanical strength in the presence of crack initiation sites (tearability):

The tearability strength and deformation are measured on a test specimen drawn at 375 mm/minute to bring about rupture of the test specimen. The tensile test specimen consists of a rubber plaque of parallelepipedal shape, with a thickness of 2.5 mm, a length of 84 mm and a width of 10 mm. Three very fine 3 mm long cuts are made using a razor blade, halfway along the length and aligned with the width of the test specimen, before starting the test. The force (N/mm) to be exerted to obtain rupture is determined and the elongation at break is measured. The energy to bring about breaking (tearability energy) of the test specimen, which is the product of the breaking stress and the elongation at break, can be determined. The test was performed in air, at a temperature of 100° C. The results are shown on a basis of 100, the arbitrary value 100 being assigned to the control in order to calculate and compare the breaking energy of the different samples tested. High values reflect good cohesion of the rubber composition despite the presence of crack initiation, which corresponds to improved tear strength performance.

### 7—Dynamic Properties:

The dynamic property tan (8) max is measured on a viscosity analyser (Metravib VA4000) according to the standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz and a temperature of 100° C., according to the standard ASTM D 1349-99, is recorded. A strain amplitude sweep is performed from 0.1% to 50% (outward cycle) and then from 50% to 0.1% (return cycle). The result exploited is the complex dynamic shear modulus G*. On the return cycle, the value of G* at 35% strain is recorded.

The results are shown on a basis of 100, the arbitrary value 100 being assigned to the control in order to calculate and compare the complex modulus G*_{35%} of the different samples tested. The value in base 100 for the test sample is calculated according to the operation: (value of the complex modulus G*_{35%} of the test sample/value of the complex modulus G*_{35%} of the control sample)×100. In this way, a result less than 100 indicates a decrease in the complex modulus G*35% and thus a decrease in the stiffness of the composition. Conversely, a result greater than 100 indicates an increase in the complex modulus G*_{35%} and thus an improvement in the stiffness of the composition.

### 8—Microstructure of the Diene Elastomers:

The microstructure of the elastomers is characterized by the near-infrared (NIR) spectroscopy technique.

Near-infrared (NIR) spectroscopy is used to quantitatively determine the content by mass of styrene in the elastomer and also its microstructure (relative distribution of the 1,2-, trans-1,4- and cis-1,4-butadiene units). The principle of the method is based on the Beer-Lambert law generalized for a multicomponent system. As the method is indirect, it involves a multivariate calibration [Vilmin, F., Dussap, C. and Coste, N., Applied Spectroscopy, 2006, 60, 619-29] performed using standard elastomers having a composition determined by ¹³C NMR. The styrene content and the microstructure are then calculated from the NIR spectrum of an elastomer film about 730 μm in thickness. The spectrum is acquired in transmission mode between 4000 and 6200 cm⁻¹ with a resolution of 2 cm⁻¹ using a Bruker Tensor 37 Fourier-transform near-infrared spectrometer equipped with an InGaAs detector cooled by the Peltier effect.

### EXAMPLES

### Test 1:

The purpose of this test is to demonstrate that the elastomer compositions of the invention offer a better compromise of properties-resistance to aggressive conditions, stiffness, deformation at break and thermal conductivity-relative to a composition of the prior art.

For this purpose, four elastomer compositions are prepared, notably intended for the manufacture of heavy-duty tyres, notably civil engineering tyres:
T0 is a control composition not comprising graphite and having a good compromise of properties-resistance to aggressive conditions, stiffness, breaking strain and thermal conductivity; it represents the prior art;
T1 is a reference composition comprising graphite;
C1 and C2 are compositions according to the invention comprising a specific graphite.

Table 2 gives the formulation of the different compositions, the contents being expressed as phr (parts by weight per hundred parts by weight of elastomers).

TABLE 2

| | T0 | T1 | C1 | C2 |
|---|---|---|---|---|
| Diene elastomer (1) | 100.00 | 100.00 | 100.00 | 100.00 |
| Acetylene black (2) | 36.50 | 26.50 | 34.00 | 26.50 |
| Silica (9) | 10.00 | 10.00 | 10.00 | 10.00 |
| Coupling agent (10) | 0.50 | 0.50 | 0.50 | 0.50 |
| PEG (11) | 0.84 | 0.84 | 0.84 | 0.84 |
| Graphite (3) | (—) | 10.00 | (—) | (—) |
| Graphite (4) | (—) | (—) | 2.50 | 10.00 |
| Antioxidant (5) | 1.00 | 1.00 | 1.00 | 1.00 |
| Stearic acid (6) | 1.50 | 1.50 | 1.50 | 1.50 |
| ZnO | 4.50 | 4.50 | 4.50 | 4.50 |
| Accelerator (7) | 1.33 | 1.33 | 1.33 | 1.33 |
| DPG (8) | 0.10 | 0.10 | 0.10 | 0.10 |
| Sulfur | 1.42 | 1.42 | 1.42 | 1.42 |
| Total reinforcing | 46.50 | 36.50 | 41.80 | 36.50 |
| filler content | | | | |
| Total filler content | 46.50 | 46.50 | 46.50 | 46.50 |

(1) Natural rubber
(2) Acetylene black having a BET specific surface area = 74 m²/g measured according to the standard ASTM D-3037 dated 1993, an iodine absorption number = 92 mg/g measured according to the standard ASTM D1510-21, an oil absorption number (OAN) measured according to the standard D2414-22 equal to 160 ml/100 g. This type of acetylene black can be sold under the reference “Denka Black”.
(3) Natural graphite with a mesh size of 150 (“150 mesh graphite”), having a specific surface area BET of 0.5 m²/g, a D₉₀ = 150 μm and an Lc of 493 nm. This graphite is sold by Imerys under the reference Timrex 80*150. The BET specific surface area, D₉₀ and crystallite size Lc are measured using the methods described above.
(4) Expanded graphite having a BET specific surface area of 25 m²/g, a D₉₀ of 105 μm and an Lc of 157 nm. This graphite is sold by Imerys under the reference Timrex C-Therm 001. The BET specific surface area, D₉₀ and crystallite size Lc are measured using the methods described above.
(5) N-(1,3-Dimethylbutyl)-N-phenyl-para-phenylenediamine, sold by Flexsys under the reference Santoflex 6-PPD.
(6) Stearin sold by the company Uniqema under the name Pristerene 4931.
(7) N-Cyclohexyl-2-benzothiazyl sulfenamide, sold by Flexsys under the reference Santocure CBS.
(8) Diphenylguanidine sold by Flexsys under the reference Perkacit.
(9) Silica “Zeosil 1165 MP” type HDS sold by the company Solvay, CTAB specific surface area equal to 160 m²/g and BET specific surface area equal to 165 m²/g.
(10) Coupling agent: bis[3-(triethoxysilyl)propyl] tetrasulfide (TESPT) silane, sold by Evonik under the reference Si69.
(11) Polyethylene glycol sold by Dow Corning under the reference Carbowax 8000.

The elastomer compositions to be tested are prepared as follows: the natural rubber is introduced into an internal mixer, filled to 70% and with an initial tank temperature of approximately 60° C., followed by the reinforcing filler, the graphite, and then the various other ingredients except for the sulfur and the vulcanization accelerator. Thermomechanical working (non-productive phase) is then performed in one or two steps (total kneading time equal to about 3 to 6 min, until a maximum “dropping” temperature of about 160-165° C. is reached). The elastomer compositions are prepared as indicated previously. The silica, coupling agent and PEG are added during the non-productive phase of the manufacturing process. The mixture thus obtained is recovered and cooled and sulfur and the vulcanization accelerator are then added on an external mixer (homofinisher) at 40° C., the whole being mixed (productive phase) for 4 to 10 minutes.

The compositions are then formed for the measurements of their physical or mechanical properties (for example in the form of test specimens) and where appropriate are cured (or vulcanized) for the measurements of the cured properties.

The properties measured after curing at 120° C. for 300 min are reported in Table 3.

TABLE 3

| Composition | T0 | T1 | C1 | C2 |
|---|---|---|---|---|
| Thermal conductivity | 100 | 113 | 113 | 155 |
| (on a basis of 100) | | | | |
| Elongation at break | 100 | 102 | 101 | 105 |
| (on a basis of 100) | | | | |
| Breaking energy (on a | 100 | 91 | 100 | 103 |
| basis of 100) | | | | |
| Tear energy (on a | 100 | 60 | 105 | 160 |
| basis of 100) | | | | |
| Stiffness (on a | 100 | 87 | 98 | 94 |
| basis of 100) | | | | |

Relative to elastomer composition TO, the use of natural graphite with a mesh size of 150 improves the thermal conductivity and the elongation at break but at the expense of the stiffness, the breaking energy and the tear energy (and thus the resistance to aggressive conditions).

The use of a graphite having a crystallite size of 157 nm (elastomer composition C1 according to the invention) surprisingly makes it possible to obtain the same thermal conductivity and elongation at break as those of the control composition T1. On the other hand, it provides properties of breaking energy, tear energy and stiffness which are significantly higher than those of the control composition T1 and comparable to those of the control composition TO. These effects are obtained with a graphite content significantly lower than the graphite contents used in the elastomer composition T1.

Advantageously, the compromise of properties-resistance to aggressive conditions, stiffness, breaking strain and thermal conductivity-is always improved even when the graphite content is increased without increasing the filler content. The elastomer composition C2 according to the invention has overall better properties than the control compositions TO and T1.

### Test 2:

The purpose of this test is to demonstrate that the elastomer compositions of the invention offer a better compromise of properties—resistance to aggressive conditions, stiffness, deformation at break and thermal conductivity—relative to a composition of the prior art. These compositions do not comprise silica.

To this end, four elastomer compositions are prepared, notably intended for the manufacture of tyres for heavy-goods vehicles:
T2 is a control composition not comprising graphite and having a good compromise of properties-resistance to aggressive conditions, stiffness, breaking strain and thermal conductivity;
T3 is a control composition comprising graphite;
C3 and C4 are compositions according to the invention comprising a specific graphite.

Table 4 gives the formulation of the different compositions, the contents being expressed as phr (parts by weight per hundred parts by weight of elastomers).

TABLE 4

| | T0 | T1 | C3 | C4 |
|---|---|---|---|---|
| Diene elastomer (1) | 100.00 | 100.00 | 100.00 | 100.00 |
| Acetylene black (2) | 45.00 | 35.00 | 41.60 | 35.00 |
| Graphite (3) | (—) | 10.00 | (—) | (—) |
| Graphite (4) | (—) | (—) | 3.40 | 10.00 |
| Antioxidant (5) | 1.00 | 1.00 | 1.00 | 1.00 |
| Stearic acid (6) | 1.50 | 1.50 | 1.50 | 1.50 |
| ZnO | 4.50 | 4.50 | 4.50 | 4.50 |
| Accelerator (7) | 1.33 | 1.33 | 1.33 | 1.33 |
| DPG (8) | 0.10 | 0.10 | 0.10 | 0.10 |
| Sulfur | 1.42 | 1.42 | 1.42 | 1.42 |
| Total reinforcing | 45.00 | 35.00 | 41.60 | 35.00 |
| filler content | | | | |
| Total filler content | 45.00 | 45.00 | 45.00 | 45.00 |

Ingredients (1) to (8) are the same as those of the compositions in Table 2.

The compositions are then formed for the measurements of their physical or mechanical properties (for example in the form of 4 mm test specimens, etc.) and where appropriate are cured (or vulcanized) for the measurements of the cured properties.

The properties measured after curing at 120° C. for 300 min are reported in Table 5.

TABLE 5

| Composition | T3 | T4 | C3 | C4 |
|---|---|---|---|---|
| Thermal conductivity | 100 | 119 | 119 | 153 |
| (on a basis of 100) | | | | |
| Elongation at break | 100 | 96 | 103 | 106 |
| (on a basis of 100) | | | | |
| Breaking energy (on a | 100 | 81 | 106 | 112 |
| basis of 100) | | | | |
| Tear energy (on a | 100 | 82 | 107 | 125 |
| basis of 100) | | | | |
| Stiffness (on a | 100 | 84 | 90 | 96 |
| basis of 100) | | | | |

As with the previous compositions, the elastomer compositions C3 and C4 according to the invention comprise the best compromise of properties-resistance to aggressive conditions, stiffness, breaking strain and thermal conductivity-relative to the control compositions T3 and T4.

1.-14. (canceled)

15. An elastomer composition for heavy-duty tires based on at least one elastomeric matrix, fillers including graphite and a reinforcing filler, and a vulcanization system,
wherein the at least one elastomeric matrix comprises at least 50 phr of a diene elastomer selected from the group consisting of isoprene elastomers, butadiene elastomers and mixtures thereof,
wherein the reinforcing filler predominantly comprises an acetylene black,
wherein the graphite has a crystallite size Lc in a range from 80 to 500 nm, and
wherein a total filler content is less than or equal to 65 phr.

16. The elastomer composition according to claim 15, wherein the total filler content is less than or equal to 60 phr.

17. The elastomer composition according to claim 15, wherein the total filler content is in a range from 20 to 65 phr.

18. The elastomer composition according to claim 15, wherein the graphite has a BET specific surface area in a range from 10 to 50 m²/g.

19. The elastomer composition according to claim 15, wherein the graphite has a particle size distribution D90 in a range from 50 to 150 μm.

20. The elastomer composition according to claim 15, wherein the graphite is an expanded graphite.

21. The elastomer composition according to claim 15, wherein the reinforcing filler further comprises at least one precipitated silica and the elastomer composition further comprises an agent for coupling the at least one precipitated silica to the diene elastomer of the at least one elastomeric matrix.

22. The elastomer composition according to claim 21, wherein a content of silica is in a range from 5 to 20 phr, and a content of coupling agent represents from 0.5% to 15% by weight relative to the amount of silica.

23. The elastomer composition according to claim 15, wherein a graphite content is in a range from 1 to 12 phr.

24. The elastomer composition according to claim 15, wherein a content of diene elastomer is in a range from 60 to 100 phr.

25. The elastomer composition according to claim 15, wherein the diene elastomer is selected from the group consisting of natural rubber, synthetic polyisoprene, isoprene/styrene copolymers, polybutadienes, ethylene/butadiene copolymers, butadiene/styrene copolymers, isoprene/butadiene copolymers, isoprene/butadiene/styrene copolymers and blends thereof.

26. The elastomer composition according to claim 15, wherein a content of reinforcing filler is less than or equal to 60 phr.

27. The elastomer composition according to claim 15, wherein the acetylene black has an oil absorption number measured according to standard ASTM D1510-21 of greater than or equal to 150 m²/g.

28. A heavy-duty tire comprising the elastomer composition according to claim 15.
